(19) United States
(12) Patent Application Publication
(10) Pub. No.: US 2025/0306447 A1
(43) Pub. Date: Oct. 2, 2025

(54) PROJECTOR

(71) Applicant: SEIKO EPSON CORPORATION, Tokyo (JP)

(72) Inventor: Koichi AKIYAMA, AZUMINO-SHI (JP)

(21) Appl. No.: 19/097,292

(22) Filed: Apr. 1, 2025

(30) Foreign Application Priority Data
Apr. 2, 2024 (JP) 2024-059439

(51) Int. Cl. G03B 21/20

(52) U.S. Cl. CPC G03B 21/208; G03B 21/2013; G03B 21/204; G03B 21/2073

(57) ABSTRACT

A projector of the present disclosure includes a first laser light emitting element that emits first light; a second laser light emitting element that emits second light having a same peak wavelength as the first light; a diffusion member on which the first light and the second light are incident; a superimposition optical system on which light emitted from the diffusion member is incident; a light modulation device that modulates light incident from the superimposition optical system in accordance with image information; and a projection optical device that projects light modulated by the light modulation device, wherein the first laser light emitting element and the second laser light emitting element have oscillation states different from each other.

The present application is based on, and claims priority from JP Application Serial Number 2024-059439, filed Apr. 2, 2024, the disclosure of which is hereby incorporated by reference herein in its entirety.

### BACKGROUND

### 1. Technical Field

The present disclosure relates to a projector.

### 2. Related Art

For the purpose of improving performance of a projector, a projector including an illumination device using a laser light source, which is a light source with a wide color gamut and high efficiency, has been proposed. JP-A-2019-40177 described below discloses an illumination device including a blue laser light source, a green laser light source, a red laser light source, a plurality of dichroic mirrors for combining each color light emitted from each laser light source, and a diffusion plate for diffusing combined light combined by the plurality of dichroic mirrors.

In the illumination device of JP-A-2019-40177, the laser light source of each color has a configuration in which a plurality of semiconductor lasers are arranged in a two-dimensional manner. However, since light from the semiconductor lasers arranged in the two-dimensional manner within each laser light source interferes with each other, there is a problem that it is difficult to sufficiently remove speckle noise in the configuration of diffusing combined light using the diffusion plate.

### SUMMARY

In order to overcome the above-described problem, a projector according to one aspect of the present disclosure includes a first laser light emitting element that emits first light; a second laser light emitting element that emits second light having a same peak wavelength as the first light; a diffusion member on which the first light and the second light are incident; a superimposition optical system on which light emitted from the diffusion member is incident; a light modulation device that modulates light incident from the superimposition optical system in accordance with image information; and a projection optical device that projects light modulated by the light modulation device, wherein the first laser light emitting element and the second laser light emitting element have oscillation states different from each other.

### BRIEF DESCRIPTION OF THE DRAWINGS

FIG. 1 is a schematic diagram showing a configuration of a projector 1 of an embodiment.

FIG. 2A is a schematic configuration diagram of an illumination device 2.

FIG. 2B is an enlarged view showing a configuration of a main part of the illumination device 2.

FIG. 3A is a diagram showing a duty ratio of a light emitting element of a first red light source package.

FIG. 3B is a diagram showing a duty ratio of a light emitting element of a second red light source package.

FIG. 3C is a diagram showing a duty ratio of a light emitting element of a third red light source package.

FIG. 3D is a diagram showing a duty ratio of a light emitting element of a fourth red light source package.

FIG. 4 is a view showing a configuration of a main part of a red light source section of a third embodiment.

FIG. 5 is a diagram showing a schematic configuration of an illumination device of a fourth embodiment.

### DESCRIPTION OF EMBODIMENTS

Hereinafter, embodiments of the present disclosure will be described with reference to the drawings. In the drawings, in order to make each component easy to see, the scale of dimensions may be changed depending on the component.

### First Embodiment

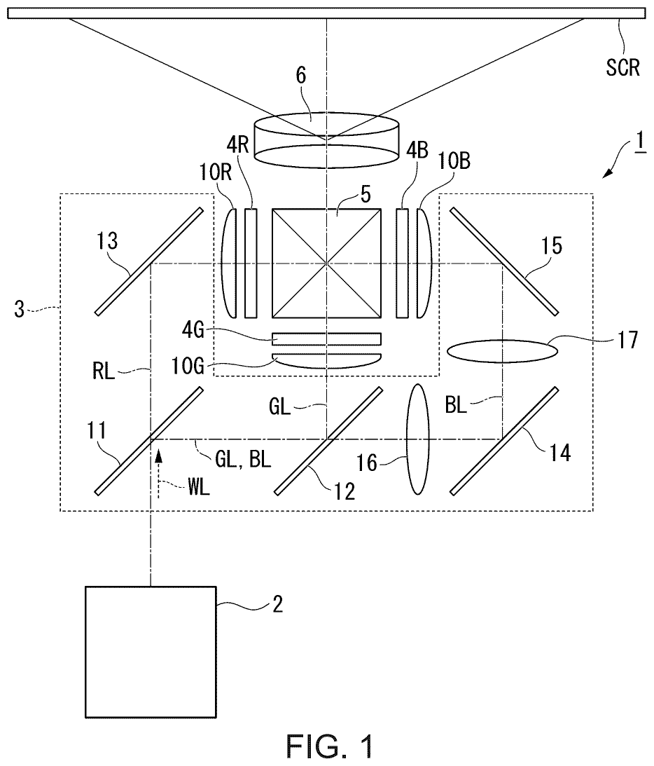

A projector according to a first embodiment of the present disclosure will be described. FIG. 1 is a schematic diagram showing a configuration of a projector 1 of the present embodiment. As shown in FIG. 1, the projector 1 of the present embodiment is a projection type image display device that displays an image on a screen SCR. The projector 1 includes an illumination device 2, a color separation optical system 3, light modulation devices 4R, 4G, and 4B, a color combining optical system 5, and a projection optical device 6. The projector 1 is a three-plate projector including three light modulation devices.

The illumination device 2 emits white light WL toward the color separation optical system 3. The white light WL is illumination light in the projector 1, and includes red light RL, green light GL, and blue light BL. A configuration of the illumination device 2 will be described later.

The color separation optical system 3 separates the white light WL into the red light RL, the green light GL, and the blue light BL. The color separation optical system 3 includes, for example, a first dichroic mirror 11, a second dichroic mirror 12, a first reflective mirror 13, a second reflective mirror 14, a third reflective mirror 15, a first relay lens 16, and a second relay lens 17.

The first dichroic mirror 11 is arranged on the optical path of the white light WL emitted from the illumination device 2 and separates the incident white light WL into the red light RL, the green light GL, and the blue light BL. The first dichroic mirror 11 transmits the red light RL and reflects the green light GL and the blue light BL. The second dichroic mirror 12 is arranged on a common optical path of the green light GL and the blue light BL emitted from the first dichroic mirror 11, and separates the green light GL from the blue light BL. The second dichroic mirror 12 transmits the blue light BL and reflects the green light GL.

The first reflective mirror 13 reflects the red light RL toward the light modulation device 4R. The second reflective mirror 14 and the third reflective mirror 15 guide the blue light BL to the light modulation device 4B. The green light GL is reflected toward the light modulation device 4G from the second dichroic mirror 12. The red light RL, the green light GL, and the blue light BL included in the white light WL correspond to light emitted from the illumination device 2.

The first relay lens 16 is arranged on an optical path of the blue light BL between the second dichroic mirror 12 and the second reflective mirror 14. The second relay lens 17 is arranged on an optical path of the blue light BL between the second reflective mirror 14 and the third reflective mirror 15. Since the first relay lens 16 and the second relay lens 17 are arranged as described above, the light loss of the blue light BL is compensated. The light loss of the blue light BL is caused by the fact that an optical path length of the blue light BL from the first dichroic mirror 11 to the light modulation device 4B is longer than an optical path length of the red light RL from the first dichroic mirror 11 to the light modulation device 4R and an optical path length of the green light GL from the first dichroic mirror 11 to the light modulation device 4G.

The light modulation device 4R is arranged on an optical path of the red light RL reflected by the first reflective mirror 13 and emitted from the first reflective mirror 13. The light modulation device 4R modulates the incident red light RL in accordance with image information input from an image input device (not shown), forms red image light, and emits red image light. The light modulation device 4G is arranged on an optical path of the green light GL reflected by the second dichroic mirror 12 and emitted from the second dichroic mirror 12. The light modulation device 4G modulates the incident green light GL in accordance with image information input from the image input device (not shown), forms green image light, and emits green image light. The light modulation device 4B is arranged on an optical path of the blue light BL reflected by the third reflective mirror 15 and emitted from the third reflective mirror 15. The light modulation device 4B modulates the incident blue light BL in accordance with image information input from the image input device (not shown), forms blue image light, and emits the blue image light. An image input device such as a personal computer or a portable terminal device is used.

For example, a transmissive liquid crystal panel is used for each of the light modulation devices 4R, 4G, and 4B. A polarizing plate (not shown) is arranged on each of the incident side and the emission side of the liquid crystal panel. A field lens 10R is arranged on an optical path of the red light RL between the first reflective mirror 13 and the light modulation device 4R. A field lens 10G is arranged on an optical path of the green light GL between the second dichroic mirror 12 and the light modulation device 4G. A field lens 10B is arranged on an optical path of the blue light BL between the third reflective mirror 15 and the light modulation device 4B.

The color combining optical system 5 is arranged across an optical path of red image light emitted from the light modulation device 4R, an optical path of green image light emitted from the light modulation device 4G, and an optical path of blue image light emitted from the light modulation device 4B. When viewed in plan view as shown in FIG. 1, or when viewed in side view, the combining position of color light in the color combining optical system 5 overlaps with the intersection of the optical path of red image light, the optical path of green image light, and the optical path of blue image light. In the color combining optical system 5, the red image light, the green image light, and the blue image light are combined with each other to form color image light. The color combining optical system 5 emits the color image light. In the color combining optical system 5, for example, a cross dichroic prism is used.

The projection optical device 6 is arranged on an optical path of the color image light emitted from the color combining optical system 5. The color image light emitted from the color combining optical system 5 corresponds to light modulated by the light modulation devices 4R, 4G, and 4B. The projection optical device 6 enlarges and projects the color image light emitted from the color combining optical system 5 and incident thereon toward the screen SCR. The color image light to be enlarged and projected from the projection optical device 6 is displayed on the screen SCR as a color image on the display surface, which faces an emission surface of the projection optical device 6.

The projection optical device 6 is configured, for example, by a plurality of optical lenses, but may be configured by a single optical lens. The optical lens includes various types of lenses, such as a plano-convex lens, a biconvex lens, a meniscus lens, an aspheric lens, a rod lens, and a free-form surface lens.

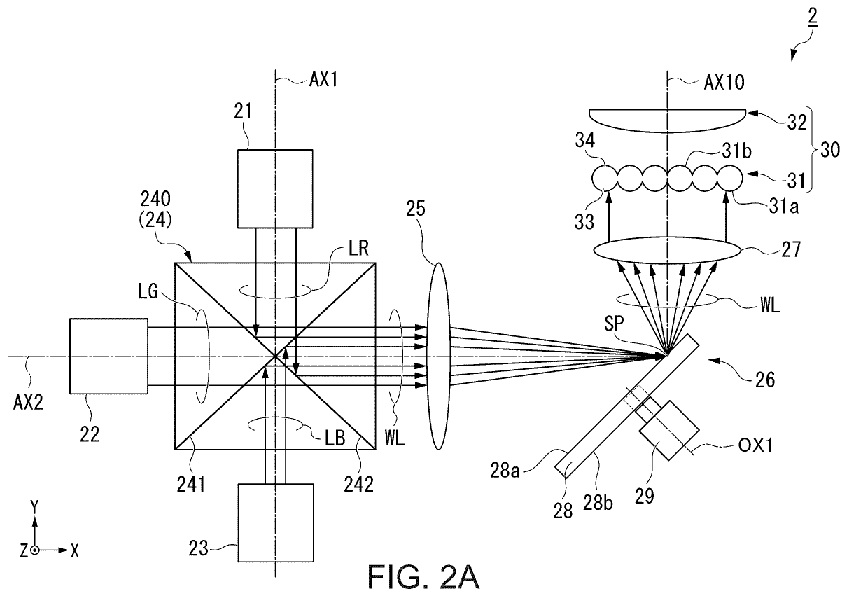

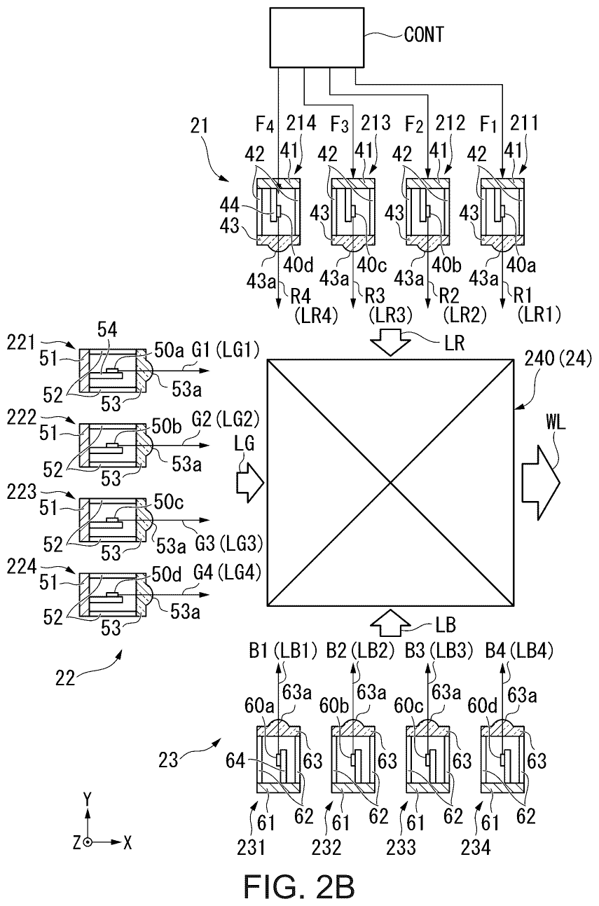

Next, configuration of the illumination device 2 will be described. FIG. 2A is a schematic configuration diagram of an illumination device 2. FIG. 2B is an enlarged view showing a configuration of a main part of the illumination device 2.

As shown in FIG. 2A, the illumination device 2 includes a red light source section 21 that emits red illumination light LR, a green light source section 22 that emits green illumination light LG, a blue light source section 23 that emits blue illumination light LB, a light combining section 24, a condensing optical system 25, a diffusion device 26, a collimating element 27, and a superimposition optical system 30.

In the following description, the arrangement of each member may be described using an XYZ coordinate system. In the present specification, an axis parallel to an optical axis AX1 of the green illumination light LG emitted from the green light source section 22 is defined as an X-axis. An axis parallel to an optical axis AX2 of each of illumination light LR and LB emitted from the red light source section 21 and the blue light source section 23 and orthogonal to the X-axis is defined as a Y-axis. An axis perpendicular to the X-axis and the Y-axis is defined as a Z-axis.

As shown in FIG. 2B, the red light source section 21 includes four light source packages arranged in one direction, that is, a first red light source package (first light source package) 211, a second red light source package (second light source package) 212, a third red light source package 213, and a fourth red light source package 214.

The first red light source package 211 includes a plurality of first red laser light emitting elements (first laser light emitting elements) 40a. The first red laser light emitting element 40a is composed of a semiconductor laser that emits a red light ray (first light) R1. The red light ray R1 is, for example, red laser light with a red wavelength band of 585 to 720 nm.

The first red light source package 211 includes a multi-emitter package structure in which a substrate 41 supporting a base member 44, on which four first red laser light emitting elements 40a are mounted along a Z-axial direction, is sealed with a cover glass 43. Note that the number of first red laser light emitting elements 40a constituting the first red light source package 211 is not limited to four.

In the first red light source package 211, the cover glass 43 is attached to the substrate 41 via a frame 42. A plurality of collimator lenses 43a are integrally provided on the cover glass 43. The collimator lens 43a is composed of a convex lens. The collimator lens 43a collimates the red light ray R1 emitted from the corresponding first red laser light emitting element 40a. The collimator lens 43a may be provided separately from the cover glass 43. Hereinafter, a plurality of the red light rays R1 emitted from the plurality of the collimator lenses 43a are collectively referred to as a red beam LR1.

Based on such a configuration, the first red light source package 211 emits the red beam LR1, which is composed of the plurality of the red light rays R1, as parallel light. Since the first red light source package 211 is composed of a multi-emitter package structure, it is possible to emit the high-luminance red beam LR1 while miniaturizing the device configuration.

The second red light source package 212 includes a plurality of second red laser light emitting elements (second laser light emitting elements) 40b arranged in an array. The second red laser light emitting element 40b is composed of a semiconductor laser that emits a red light ray (second light) R2 having the same peak wavelength as the red light ray R1. Here, the peak wavelength being the same as that of the red light ray R1 does not necessarily mean that the peak wavelengths of the red light rays R1 and R2 are completely the same, but also includes states with a difference of +2 nm, and more desirably with a difference of +1 nm.

The second red light source package 212 includes a multi-emitter package structure similar to the first red light source package 211. Therefore, the second red light source package 212 is configured by sealing a substrate 41, on which four of the second red laser light emitting elements 40b are mounted along the Z-axial direction, with a cover glass 43. Based on such a configuration, the second red light source package 212 emits a red beam LR2, which is composed of a plurality of the red light rays R2, as parallel light. Since the second red light source package 212 is composed of a multi-emitter package structure, it is possible to emit the high-luminance red beam LR2 while miniaturizing the device configuration.

A third red light source package 213 includes a plurality of third red laser light emitting elements 40c arranged in an array. The third red laser light emitting element 40c is composed of a semiconductor laser that emits a red light ray R3 having the same peak wavelength as the red light rays R1 and R2.

The third red light source package 213 includes a multi-emitter package structure similar to the first red light source package 211 or the second red light source package 212. Therefore, the third red light source package 213 is configured by sealing a substrate 41, on which four of the third red laser light emitting elements 40c are mounted along the Z-axial direction, with a cover glass 43. Based on such a configuration, the third red light source package 213 emits a red beam LR3, which is composed of a plurality of the red light rays R3, as parallel light. Since the third red light source package 213 is composed of a multi-emitter package structure, it is possible to emit the high-luminance red beam LR3 while miniaturizing the device configuration.

A fourth red light source package 214 includes a plurality of fourth red laser light emitting elements 40d arranged in an array. The fourth red laser light emitting element 40d is composed of a semiconductor laser that emits a red light ray R4 having the same peak wavelength as the red light rays R1, R2, and R3.

The fourth red light source package 214 includes a multi-emitter package structure similar to the first red light source package 211, the second red light source package 212, or the third red light source package 213. Therefore, the fourth red light source package 214 is configured by sealing a substrate 41, on which four of the fourth red laser light emitting elements 40d are mounted along the Z-axial direction, with a cover glass 43. Based on such a configuration, the fourth red light source package 214 emits a red beam LR4, which is composed of a plurality of the red light rays R4, as parallel light. Since the fourth red light source package 214 is composed of a multi-emitter package structure, it is possible to emit the high-luminance red beam LR4 while miniaturizing the device configuration.

In this way, the red light source section 21 emits the red illumination light LR including the red beams LR1 to LR4 emitted from the light source packages 211 to 214 along the optical axis AX1, and causes the red illumination light LR to be incident on the light combining section 24 positioned on a −Y side.

The oscillation states of the light source packages 211 to 214 of the red light source section 21 are different from each other. In the case of the present embodiment, each light source package 211 to 214 has a different drive frequency for driving each of the light emitting elements. Here, drive frequency refers to the frequency at which a predetermined drive electric current is applied to the light emitting element in a pulse form.

The red light source section 21, for example, has a first drive frequency F₁ of 120 Hz in the first red laser light emitting element 40a of the first red light source package 211, a second drive frequency F₂ of 160 Hz in the second red laser light emitting element 40b of the second red light source package 212, a third drive frequency F₃ of 180 Hz in the third red laser light emitting element 40c of the third red light source package 213, and a fourth drive frequency F₄ of 200 Hz in the fourth red laser light emitting element 40d of the fourth red light source package 214. Further, the drive frequencies of the light source packages 211 to 214 do not have an integer multiple relationship with each other. Drive frequencies F₁ to F₄ are input, via a control device CONT, to respective light emitting elements 40a to 40d of respective light source packages 211 to 214.

That is, in the present embodiment, the first drive frequency F₁ of the first red laser light emitting element 40a of the first red light source package 211 and the second drive frequency F₂ of the second red laser light emitting element 40b of the second red light source package 212 are different from each other. The first drive frequency F₁ and the second drive frequency F₂ do not have an integer multiple relationship with each other.

The green light source section 22 includes four light source packages arranged in one direction, that is, a first green light source package 221, a second green light source package 222, a third green light source package 223, and a fourth green light source package 224.

The first green light source package 221 includes a plurality of first green laser light emitting elements (third laser light emitting elements) 50a. The first green laser light emitting element 50a is composed of a semiconductor laser that emits a green light ray (third light) G1 having a wavelength band different from that of the red light ray R1. The green light ray G1 is, for example, green laser light with a wavelength band of 495 nm to 585 nm.

The first green light source package 221 includes a multi-emitter package structure in which a substrate 51, which supports a base member 54 on which four first green laser light emitting elements 50a are mounted along the Z-axial direction, is sealed with a cover glass 53. The number of the first green laser light emitting elements 50a constituting the first green light source package 221 is not limited to four.

In the first green light source package 221, the cover glass 53 is attached to the substrate 51 via a frame 52. A plurality of collimator lenses 53a are integrally provided on the cover glass 53. The collimator lens 53a is composed of a convex lens. The collimator lens 53a collimates the green light ray G1 emitted from the corresponding first green laser light emitting element 50a. The collimator lens 53a may be provided separately from the cover glass 53. Hereinafter, a plurality of the green light rays G1 emitted from the plurality of the collimator lenses 53a are collectively referred to as a green beam LG1.

Based on such a configuration, the first green light source package 221 emits a green beam LG1, which is composed of the plurality of the green light rays G1, as parallel light. Since the first green light source package 221 is composed of a multi-emitter package structure, it is possible to emit the high-luminance green beam LG1 while miniaturizing the device configuration.

A second green light source package 222 includes a plurality of second green laser light emitting elements (fourth laser light emitting elements) 50b arranged in an array. The second green laser light emitting element 50b is composed of a semiconductor laser that emits a green light ray (fourth light) G2 having the same peak wavelength as the green light ray G1. Here, the peak wavelength being the same as that of the green light ray G1 does not necessarily mean that the peak wavelengths of the green light rays G1 and G2 are completely the same, but also means that there is a difference of ±2 nm, more desirably a difference of ±1 nm.

The second green light source package 222 includes a multi-emitter package structure similar to the first green light source package 221. Therefore, the second green light source package 222 is configured by sealing a substrate 51, on which four second green laser light emitting elements 50b are mounted along the Z-axial direction, with a cover glass 53. Based on such a configuration, the second green light source package 222 emits a green beam LG2, which is composed of a plurality of the green light rays G2, as parallel light. Since the second green light source package 222 is composed of a multi-emitter package structure, it is possible to emit the high-luminance green beam LG2 while miniaturizing the device configuration.

A third green light source package 223 includes a plurality of third green laser light emitting elements 50c arranged in an array. The third green laser light emitting element 50c is composed of a semiconductor laser that emits a green light ray G3 having the same peak wavelength as the green light rays G1 and G2.

The third green light source package 223 includes a multi-emitter package structure similar to the first green light source package 221 or the second green light source package 222. Therefore, the third green light source package 223 is configured by sealing a substrate 51, on which the four third green laser light emitting elements 50c are mounted along the Z-axial direction, with a cover glass 53. Based on such a configuration, the third green light source package 223 emits a green beam LG3, which is composed of a plurality of the green light rays G3, as parallel light. Since the third green light source package 223 is composed of a multi-emitter package structure, it is possible to emit the high-luminance green beam LG3 while miniaturizing the device configuration.

A fourth green light source package 224 includes a plurality of fourth green laser light emitting elements 50d arranged in an array. The fourth green laser light emitting element 50d is composed of a semiconductor laser that emits a green light ray G4 having the same peak wavelength as the green light rays G1, G2, and G3.

The fourth green light source package 224 includes a multi-emitter package structure similar to the first green light source package 221, the second green light source package 222, or the third green light source package 223. Therefore, the fourth green light source package 224 is configured by sealing a substrate 51, on which the four fourth green laser light emitting elements 50d are mounted along the Z-axial direction, with a cover glass 53. Based on such a configuration, the fourth green light source package 224 emits a green beam LG4, which is composed of a plurality of the green light rays G4, as parallel light. Since the fourth green light source package 224 is composed of a multi-emitter package structure, it is possible to emit the high-luminance green beam LG4 while miniaturizing the device configuration.

In this way, the green light source section 22 emits the green illumination light LG including the green beams LG1 to LG4 emitted from the light source packages 221 to 224 along the optical axis AX2, and causes the green illumination light LG to be incident on the light combining section 24 positioned on a +X side.

Similar to the red light source section 21, the oscillation states of the light source packages 221 to 224 of the green light source section 22 are different from each other. That is, in the present embodiment, the first green laser light emitting element 50a and the second green laser light emitting element 50b have different oscillation states from each other. In the case of the present embodiment, each light source package 221 to 224 has a different drive frequency for driving each of the light emitting elements 50a to 50d. The drive frequencies of the light source packages 221 to 224 do not have an integer multiple relationship with each other.

The blue light source section 23 includes four light source packages arranged in one direction, that is, a first blue light source package 231, a second blue light source package 232, a third blue light source package 233, and a fourth blue light source package 234.

The first blue light source package 231 includes a plurality of first blue laser light emitting elements (fifth laser light emitting elements) 60a. The first blue laser light emitting element 60a is composed of a semiconductor laser that emits a blue light ray (fifth light) B1 having a wavelength band different from that of the red light ray R1 and the green light ray G1. The blue light ray B1 is, for example, blue laser light with a wavelength band of 380 nm to 495 nm.

The first blue light source package 231 includes a multi-emitter package structure in which a substrate 61, which supports a base member 64 on which four first blue laser light emitting elements 60a are mounted along the Z-axial direction, is sealed with a cover glass 63. The number of the first blue laser light emitting elements 60a constituting the first blue light source package 231 is not limited to four.

In the first blue light source package 231, the cover glass 63 is attached to the substrate 61 via a frame 62. A plurality of collimator lenses 63a are integrally provided on the cover glass 63. The collimator lens 63a is composed of a convex lens. The collimator lens 63a collimates the blue light ray B1 emitted from the corresponding first blue laser light emitting element 60a. The collimator lens 63a may be provided separately from the cover glass 63. Hereinafter, a plurality of the blue light rays Bl emitted from the plurality of the collimator lenses 63a are collectively referred to as a blue beam LB1.

Based on such a configuration, the first blue light source package 231 emits the blue beam LB1, which is composed of the plurality of the blue light rays B1, as parallel light.

A second blue light source package 232 includes a plurality of second blue laser light emitting elements (sixth laser light emitting elements) 60b arranged in an array. The second blue laser light emitting element 60b is composed of a semiconductor laser that emits a blue light ray (sixth light) B2 having the same peak wavelength as the blue light ray B1. Here, the peak wavelength being the same as that of the blue light ray B1 does not necessarily mean that the peak wavelengths of the blue light rays B1 and B2 are completely the same, but also means that there is a difference of ±2 nm, more desirably a difference of ±1 nm.

The second blue light source package 232 includes a multi-emitter package structure similar to the first blue light source package 231. Therefore, the second blue light source package 232 is configured by sealing a substrate 61, on which the four second blue laser light emitting elements 60b are mounted along the Z-axial direction, with a cover glass 63. Based on such a configuration, the second blue light source package 232 emits a blue beam LB2, which is composed of a plurality of the blue light rays B2, as parallel light.

A third blue light source package 233 includes a plurality of third blue laser light emitting elements 60c arranged in an array. The third blue laser light emitting element 60c is composed of a semiconductor laser that emits a blue light ray B3 having the same peak wavelength as the blue light rays B1 and B2.

The third blue light source package 233 includes a multi-emitter package structure similar to the first blue light source package 231 or the second blue light source package 232. Therefore, the third blue light source package 233 is configured by sealing a substrate 61, on which the four third blue laser light emitting elements 60c are mounted along the Z-axial direction, with a cover glass 63. Based on such a configuration, the third blue light source package 233 emits a blue beam LB3, which is composed of a plurality of the blue light rays B3, as parallel light.

A fourth blue light source package 234 includes a plurality of fourth blue laser light emitting elements 60d arranged in an array. The fourth blue laser light emitting element 60d is composed of a semiconductor laser that emits a blue light ray B4 having the same peak wavelength as the blue light rays B1, B2, and B3.

The fourth blue light source package 234 includes a multi-emitter package structure similar to the first blue light source package 231, the second blue light source package 232, or the third blue light source package 233. Therefore, the fourth blue light source package 234 is configured by sealing a substrate 61, on which the four fourth blue laser light emitting elements 60d are mounted along the Z-axial direction, with a cover glass 63. Based on such a configuration, the fourth blue light source package 234 emits a blue beam LB4, which is composed of a plurality of the blue light rays B4, as parallel light.

In this way, the blue light source section 23 emits the blue illumination light LB including the blue beams LB1 to LB4 emitted from the light source packages 231 to 234 along the optical axis AX1, and causes the blue illumination light LB to be incident on the light combining section 24 positioned on a +Y side.

Similar to the red light source section 21 and the green light source section 22, the oscillation states of the light source packages 231 to 234 of the blue light source section 23 are different from each other. That is, in the present embodiment, the first blue laser light emitting element 60a and the second blue laser light emitting element 60b have different oscillation states from each other. In the case of the present embodiment, each light source package 231 to 234 has a different drive frequency for driving the light emitting elements 60a to 60d. The drive frequencies of the light source package 231 to 234 do not have an integer multiple relationship with each other.

The light combining section 24 is arranged across an optical path of the red illumination light LR emitted from the red light source section 21, an optical path of the green illumination light LG emitted from the green light source section 22, and an optical path of the blue illumination light LB emitted from the blue light source section 23. When viewed in plan view as shown in FIG. 2A, or when viewed in side view, the combining position of color light in the light combining section 24 overlaps with an intersection of the optical path of the red illumination light LR, the optical path of the green illumination light LG, and the optical path of the blue illumination light LB, that is, the intersection of the optical axis AX1 and the optical axis AX2.

In the light combining section 24, the incident red illumination light LR, green illumination light LG, and blue illumination light LB combine with each other, and the white light WL is generated. The white light WL corresponds to combined light. The light combining section 24 emits the white light WL along the optical axis AX2. The optical axis AX2 of the white light WL is on the same line as the optical axis AX2 of the green illumination light LG. The optical axis AX2 of the white light WL is an axis that extends along the optical axis AX2 of the green illumination light LG toward the light combining section 24, passing through the combining position of color light in the light combining section 24, and then further extends in the opposite direction from the green light source section 22 with respect to the light combining section 24.

In the light combining section 24, for example, a cross dichroic prism 240 is used. The cross dichroic prism 240 includes a first dichroic mirror 241 and a second dichroic mirror 242. In a plan view or a side view in which the optical axis AX1 and the optical axis AX2 are orthogonal to each other, a reflective surface of the first dichroic mirror 241 and a reflective surface of the second dichroic mirror 242 are each inclined with respect to the optical axis AX1 and the optical axis AX2. In plan view or side view, the angle formed by the reflective surface of the first dichroic mirror 241 and the reflective surface of the second dichroic mirror 242 with the optical axes AX1 and AX2 is 45°. In plan view or side view in which the optical axes AX1 and AX2 are orthogonal to each other, the reflective surface of the first dichroic mirror 241 and the reflective surface of the second dichroic mirror 242 are orthogonal to each other.

The first dichroic mirror 241 reflects the blue illumination light LB and transmits the green illumination light LG and the red illumination light LR. The second dichroic mirror 242 reflects the red illumination light LR and transmits the blue illumination light LB and the green illumination light LG. The red illumination light LR emitted from the red light source section 21 is incident on the second dichroic mirror 242 along the optical axis AX1, is reflected by the second dichroic mirror 242, is emitted to a side that is opposite from the green light source section 22 along the optical axis AX2, and transmits through the first dichroic mirror 241. The green illumination light LG emitted from the green light source section 22 is incident on the first dichroic mirror 241 along the optical axis AX2, goes straight, and transmits through the first dichroic mirror 241 and the second dichroic mirror 242. The blue illumination light LB emitted from the blue light source section 23 is incident on the first dichroic mirror 241 along the optical axis AX1, is reflected by the first dichroic mirror 241, is emitted to a side that is opposite from the green light source section 22 along the optical axis AX2, and transmits through the second dichroic mirror 242.

As described above, the red illumination light LR, the green illumination light LG, and the blue illumination light LB emitted from the first dichroic mirror 241 and the second dichroic mirror 242 are combined with each other, and the white light WL of white color is generated. The white light WL is emitted along the optical axis AX2 from a side surface of the cross dichroic prism 240 that is opposite from a side surface facing the green light source section 22.

The condensing optical system 25 is arranged on an optical path of the white light WL between the light combining section 24 and the diffusion device 26. The condensing optical system 25 condenses the white light WL in a state of being emitted from the light combining section 24 and collimated toward a diffusion member 28 of the diffusion device 26. The center of the diffusion member 28 in a direction orthogonal to the optical axis AX2 substantially overlaps with the optical axis AX2. The condensing optical system 25, for example, is a biconvex lens, but may also be an optical element with a light condensing function other than a biconvex lens, may be a plano-convex lens, or may be composed of a plurality of optical lenses.

The diffusion device 26 is arranged on an optical path of the white light WL emitted from the condensing optical system 25. The diffusion device 26 diffuses and emits the white light WL that is incident while being condensed by the condensing optical system 25. The diffusion device 26 is, for example, a reflecting type diffusion device, and diffuses and reflects the incident white light WL.

The diffusion device 26 includes a diffusion member 28 formed of a diffusion plate and a drive device 29. The diffusion member 28 includes an incident surface 28a irradiated with the white light WL condensed by the condensing optical system 25 and a back surface 28b on the opposite side from the incident surface 28a. The diffusion member 28 is arranged with the incident surface 28a facing the condensing optical system 25. In plan view or side view in which the optical axis AX1 and the optical axis AX2 are orthogonal to each other, the angle formed by the incident surface 28a and the optical axis AX2 is 45°.

The diffusion member 28 is mounted on the drive device 29 in a state capable of rotating about a rotation axis OX1 as the center. The drive device 29 rotates the diffusion member 28 about the rotation axis OX1 as the center. The drive device 29 is, for example, a motor. The drive device 29 may be any device capable of rotating the diffusion member 28 as described above and is not limited to a motor.

In the diffusion device 26, the condensed spot SP of the white light WL is formed on the incident surface 28a of the diffusion member 28. The incident surface 28a includes a scattering surface including a structure with indentations and protrusions for scattering the white light WL. The white light WL diffused by the diffusion member 28 is emitted as diffused light from the condensed spot SP along the illumination optical axis AX, and is incident on the collimating element 27. The illumination optical axis AX passes through the center of an irradiation region of the condensed spot SP on the incident surface 28a of the diffusion member 28 and is an axis parallel to the optical axis AX1.

The collimating element 27 collimates the white light WL in a state of being emitted from the diffusion member 28 and being diverged and diffused. The center in a direction orthogonal to the illumination optical axis AX of the collimating element 27 substantially overlaps with the illumination optical axis AX. The collimating element 27 is, for example, a biconvex lens, but may also be an optical element with a light condensing function other than a biconvex lens, may be a plano-convex lens, or may be composed of a plurality of optical lenses. When constituting the collimating element 27 by a single optical lens, by using an aspheric lens, it is possible to further enhance the accuracy of collimation.

The white light WL diffused by the diffusion member 28 of the diffusion device 26 is incident on the superimposition optical system 30. The superimposition optical system 30 includes a multi-lens array 31 and a superimposing lens 32. The superimposition optical system 30 homogenizes the illuminance distribution of the white light WL emitted from the collimating element 27 in an image formation region of each of the light modulation devices 4R, 4G, and 4B arranged in the subsequent stage.

The multi-lens array 31 is arranged on an optical path of the white light WL that is emitted from the collimating element 27 and is collimated. The multi-lens array 31 is, for example, a double-sided multi-lens array. The double-sided multi-lens includes a plurality of first microlenses 33 for splitting the white light WL emitted from the collimating element 27 into a plurality of small beams. The plurality of the first microlenses 33 are adjacent to each other along a plane orthogonal to the illumination optical axis AX and are arranged in a matrix. The first microlenses 33 are, for example, plano-convex lenses that are convex on the incident side. The multi-lens array 31 includes a first multi-lens surface 31a provided on an incident side along the shape of the plano-convex lens constituting the first microlenses 33. A double-sided multi-lens includes the same number of second microlenses 34 as first microlenses 33 in a plane orthogonal to the illumination optical axis AX. The respective second microlenses 34 are arranged adjacent to each other in a matrix along a plane orthogonal to the illumination optical axis AX, and overlap with the respective first microlenses 33. The second microlenses 34 are, for example, plano-convex lenses that are convex on the emission side. The emission-side flat surface of each of the plurality of the second microlenses 34 is common to the incident-side flat surface of each of the plurality of the first microlenses 33. A multi-lens array 31 includes a second multi-lens surface 31b provided on an emission side along the shape of the plano-convex lens constituting the second microlenses 34.

The superimposing lens 32 condenses the plurality of small beams of the white light WL emitted from the multi-lens array 31 and, in cooperation with the plurality of second microlenses 34 of the multi-lens array 31, superimposes the beams on each other in image formation regions, or in the vicinity of the image formation regions, of the light modulation devices 4R, 4G, and 4B. The superimposing lens 32, for example, is a plano-convex lens, but may also be an optical element with a light condensing function other than a plano-convex lens, may be a biconvex lens, or may be composed of a plurality of optical lenses.

Here, since each color illumination light LR, LG, and LB included in the white light WL is coherent light, there is a possibility that interference of light may occur. The illumination device 2 of the present embodiment can reduce speckle noise caused by the white light WL by diffusing the white light WL using the diffusion member 28 of the diffusion device 26.

In the projector 1 of the present embodiment, by making the oscillation state of each light emitting element of the red light source section 21, the green light source section 22, and the blue light source section 23 different from each other, the effect of reducing speckle noise by the diffusion member 28 is further enhanced.

In the projector 1 of the present embodiment, the drive frequencies of the light emitting elements 40a to 40d of the light source packages 211 to 214 in the red light source section 21 are made different from each other, thereby suppressing mutual interference between the red beams LR1 to LR4 emitted from the light source packages 211 to 214. At this time, since the drive frequencies of the light source packages 211 to 214 do not have an integer multiple relationship with each other, the drive frequency of each is not included in the other drive frequencies. Therefore, it is possible to suppress mutual interference between the red beams LR1 to LR4 more effectively.

In the projector 1 of the present embodiment, the drive frequencies of the light emitting elements 50a to 50d of the light source packages 221 to 224 in the green light source section 22 are made different mutual from each other, thereby suppressing interference between the green beams LG1 to LG4 emitted from the light source packages 221 to 224. At this time, since the drive frequencies of the light source packages 221 to 224 do not have an integer multiple relationship with each other, it is possible to satisfactorily suppress mutual interference of the green beams LG1 to LG4.

In the projector 1 of the present embodiment, the drive frequencies of the light emitting elements 60a to 60d of the light source packages 231 to 234 in the blue light source section 23 are made different from each thereby other, suppressing mutual interference between the blue beams LB1 to LB4 emitted from the light source packages 231 to 234. At this time, since the drive frequencies of the light source packages 231 to 234 do not have an integer multiple relationship with each other, it is possible to satisfactorily suppress mutual interference of the blue beams LB1 to LB4.

Thus, in the projector 1 of the present embodiment, the red beams LR1 to LR4 included in the red illumination light LR, the green beams LG1 to LG4 included in the green illumination light LG, and the blue beams LB1 to LB4 included in the blue illumination light LB can superimpose a plurality of speckle patterns that do not mutually interfere on a screen, which is a projected surface, respectively.

Therefore, according to the projector 1 of the present embodiment, it is possible to display a high-quality image with reduced speckle noise of the color illumination light LR, LG and LB.

### Second Embodiment

Next, a second embodiment of the present disclosure will be described.

In the projector 1 according to the first embodiment, an example has been described where oscillation states of light emitting elements are made different from each other by making the drive frequencies of the light emitting elements of the red light source section 21, the green light source section 22, and the blue light source section 23 different from each other, but in the present embodiment, oscillation states of the light emitting elements are made different from each other by another method.

In the present embodiment, each light emitting element of the red light source section 21, the green light source section 22, and the blue light source section 23 is controlled by pulse width modulation (PWM) to adjust the luminance of emitted light. In PWM control, the lighting and light-off of each light emitting element is periodically switched, and the luminance is adjusted by changing the ratio between the lighting time (ON time) and the light-off time (OFF time). Hereinafter, the ratio between the lighting time and the light-off time of each light emitting element is referred to as the duty ratio.

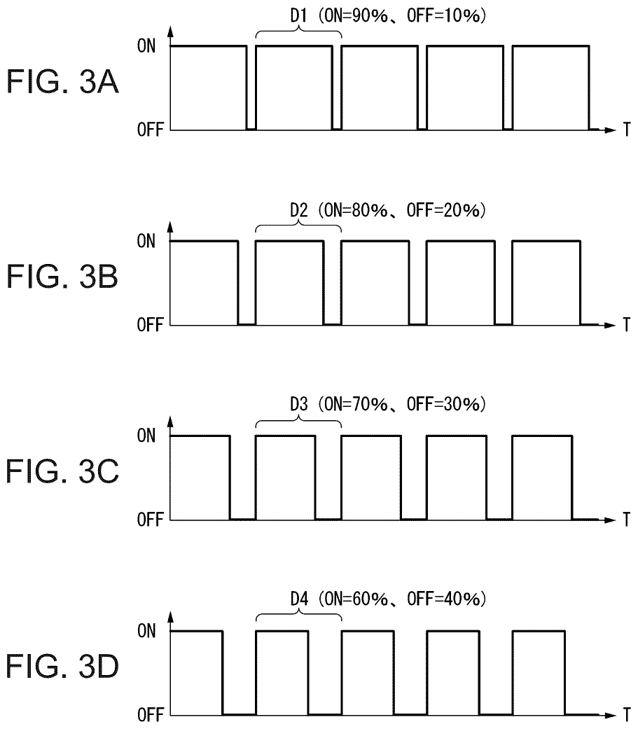

FIGS. 3A to 3D are diagrams showing the duty ratios of the light emitting elements 40a to 40d of the light source packages 211 to 214, respectively. The horizontal axis of each graph shown in FIGS. 3A to 3D represents time T.

For example, as shown in FIGS. 3A to 3D, the red light source section 21 of the present embodiment is set to a first duty ratio Dl for the first red laser light emitting element 40a of the first red light source package 211, a second duty ratio D2 for the second red laser light emitting element 40b of the second red light source package 212, a third duty ratio D3 for the third red laser light emitting element 40c of the third red light source package 213, and a fourth duty ratio D4 for the fourth red laser light emitting element 40d of the fourth red light source package 214. The first duty ratio D1 is set to ON: 90% and OFF: 10%, the second duty ratio D2 is set to ON: 80% and OFF: 20%, the third duty ratio D3 is set to ON: 70% and OFF: 30%, and the fourth duty ratio D4 is set to ON: 60% and OFF: 40%.

Thus, the red light source section 21, when performing PWM control on each light emitting element 40a to 40d of the light source packages 211 to 214, makes the duty ratios D1 to D4 of the light emitting element 40a to 40d different from each other. By this, by differentiating the oscillation state of the red beams LR1 to LR4 emitted from the light source packages 211 to 214, the red light source section 21 can suppress mutual interference of the red beams LR1 to LR4.

When the green light source section 22 performs PWM control of the light emitting elements 50a to 50d of the light source packages 221 to 224, the duty ratios of the light emitting elements 50a to 50d are different from each other, similarly to the red light source section 21. By this, the green light source section 22 can suppress the mutual interference of the green beams LG1 to LG4 emitted from the light source packages 221 to 224.

When the blue light source section 23 performs PWM control of the light emitting elements 60a to 60d of the light source packages 231 to 234, the duty ratios of the light emitting elements 60a to 60d are different from each other, similarly to the red light source section 21. By this, the blue light source section 23 can suppress the mutual interference of the blue beams LB1 to LB4 emitted from the light source packages 231 to 234.

Thus, according to the configuration of the present embodiment, the red beams LR1 to LR4 included in the red illumination light LR, the green beams LG1 to LG4 included in the green illumination light LG, and the blue beams LB1 to LB4 included in the blue illumination light LB can be superimposed with a plurality of speckle patterns that do not interfere with each other on a screen, which is a projected surface. Therefore, also in the projector of the present embodiment, it is possible to display a high-quality image with reduced speckle noise of each color illumination light LR, LG and LB.

### Third Embodiment

Next, a third embodiment of the present disclosure will be described.

The basic configuration of the projector in the third embodiment is the same as that in the first embodiment, and the configuration of the illumination device differs from that in the first embodiment. Therefore, the description of the basic configuration of the projector is omitted.

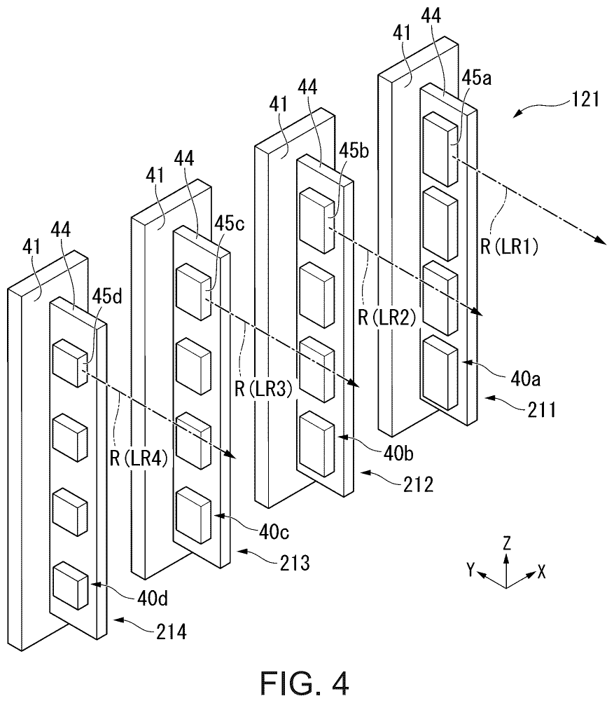

FIG. 4 is a view showing a configuration of a main part of a red light source section 121 of the present embodiment.

As shown in FIG. 4, the red light source section 121 includes light emitting elements 40a to 40d of light source packages 211 to 214 that differ in size from one another. The light emitting elements 40a to 40d each includes a light emitting surface for emitting red light rays R1 to R4. Here, the light emitting surface of the first red laser light emitting element 40a is referred to as a first light emitting surface 45a, the light emitting surface of the second red laser light emitting element 40b is referred to as a second light emitting surface 45b, the light emitting surface of the third red laser light emitting element 40c is referred to as a third light emitting surface 45c, and the light emitting surface of the fourth red laser light emitting element 40d is referred to as a fourth light emitting surface 45d. The ratio of the width in the Y-axial direction and the width in the X-axial direction of the light emitting surface 45a is referred to as the aspect ratio.

In the present embodiment, the aspect ratios of the light emitting surfaces 45a to 45d are different from each other, and the dimensions of the light emitting surfaces 45a to 45d in the Y-axial direction are different from each other. In a laser light emitting element, the number of modes of multimode oscillation varies depending on the size of the aspect ratio of a light emitting surface. Therefore, the light emitting elements 40a to 40d have different oscillation states from each other.

Thus, the red light source section 121 can suppress mutual interference between the red beams LR1 to LR4 emitted from the light source packages 211 to 214 by varying the aspect ratios of the light emitting surfaces 45a to 45d of the light emitting elements 40a to 40d of the light source packages 211 to 214.

Although not shown in the present embodiment, the green light source section and the blue light source section also include the same configuration as the red light source section 121.

That is, the green light source section, by making the aspect ratio of each light emitting surface of the first to fourth green laser light emitting elements different from each other, makes the oscillation states of the first to fourth green laser light emitting elements different from each other. By this, the green light source section can suppress the mutual interference of the green beams LG1 to LG4 emitted from the first to fourth green light source packages.

The blue light source section, by the aspect ratio of the light emitting surfaces of the first to fourth blue laser light emitting elements being different from each other, makes the oscillation states of the first to fourth blue laser light emitting elements different from each other. By this, the blue light source section can suppress the mutual interference of the blue beams LB1 to LB4 emitted from the first to fourth blue light source packages.

Thus, according to the configuration of the present embodiment, the red beams LR1 to LR4 included in the red illumination light LR, the green beams LG1 to LG4 included in the green illumination light LG, and the blue beams LB1 to LB4 included in the blue illumination light LB can be superimposed with a plurality of speckle patterns that do not interfere with each other on a screen, which is a projected surface. Therefore, also in the projector of the present embodiment, it is possible to display a high-quality image with reduced speckle noise of each color illumination light LR, LG and LB.

### Fourth Embodiment

Next, a fourth embodiment of the present disclosure will be described.

The projector of the fourth embodiment is different from that of the first embodiment in the configuration of the illumination device. Hereinafter, the configuration of the illumination device will be mainly described. Components common to the first embodiment are assigned the same reference symbols, and their detailed description is omitted.

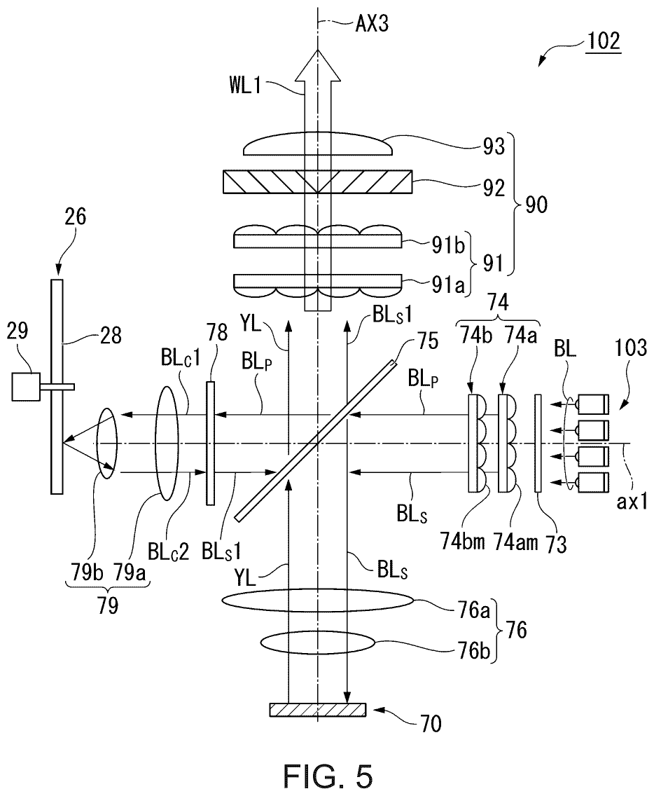

FIG. 5 is a diagram showing a schematic configuration of an illumination device 102 of the present embodiment.

As shown in FIG. 5, the illumination device 102 includes an excitation light source section 103, a first phase difference plate 73, a homogenizer optical system 74, a polarization separation element (light separating and combining element) 75, a first condensing optical system 76, a wavelength conversion element 70, a second phase difference plate 78, a second condensing optical system 79, the diffusion device 26, and a superimposition optical system 90.

Among these components, the excitation light source section 103, the first phase difference plate 73, the homogenizer optical system 74, the polarization separation element 75, the second phase difference plate 78, the second condensing optical system 79, and the diffusion device 26 are sequentially arranged side by side on an optical axis ax1.

On the other hand, the wavelength conversion element 70, the first condensing optical system 76, and the polarization separation element 75 are sequentially arranged side by side on an illumination optical axis AX3 of the illumination device 102. The optical axis ax1 and the illumination optical axis AX3 are in the same plane and are orthogonal to each other.

The excitation light source section 103 of the present embodiment includes the same configuration as the blue light source section 23 of the illumination device 2 of the first embodiment. The optical axis ax1 of the excitation light source section 103 is orthogonal to the illumination optical axis AX3 of the illumination device 102.

That is, as was shown in FIG. 2B, the excitation light source section 103 includes four light source packages arranged in one direction, that is, the first blue light source package 231, the second blue light source package 232, the third blue light source package 233, and the fourth blue light source package 234. In the present embodiment, the first blue laser light emitting element 60a of the first blue light source package 231 corresponds to the “first laser light emitting element” in the claims, and the second blue laser light emitting element 60b of the second blue light source package 232 corresponds to the “second laser light emitting element” in the claims.

Based on such a configuration, the excitation light source section 103 of the present embodiment can emit, as parallel light, an excitation light BL composed of a plurality of blue beams in which mutual interference is suppressed by making the oscillation states of the respective light emitting elements different from each other.

The excitation light BL emitted from the excitation light source section 103 is incident on the first phase difference plate 73. The first phase difference plate 73 is, for example, a rotatable ½ wavelength plate. The excitation light BL emitted from the excitation light source section 103 is linearly polarized light. Therefore, by appropriately setting a rotation angle of the first phase difference plate 73 formed of the ½ wavelength plate, the excitation light BL transmitted through the first phase difference plate 73 can be converted into light including a light ray BLs of a S-polarized component and a light ray BLp of a P-polarized component with respect to the polarization separation element 75 at a predetermined ratio.

The light including the light ray BLs and the light ray BLp is incident on the homogenizer optical system 74. The homogenizer optical system 74 homogenizes the illuminance distribution of the light ray BLs on the wavelength conversion element 70 in cooperation with the first condensing optical system 76. The homogenizer optical system 74 homogenizes the illuminance distribution of blue light BLc1 (to be described later) on the diffusion device 26 in cooperation with the second condensing optical system 79.

The homogenizer optical system 74 is formed of, for example, a first multi-lens array 74a and a second multi-lens array 74b. The first multi-lens array 74a includes a plurality of first lenses 74am, and the second multi-lens array 74b includes a plurality of second lenses 74bm. The plurality of the second lenses 74bm correspond to the plurality of the first lenses 74am, respectively.

The wavelength conversion element 70 and the diffusion device 26 are arranged at positions optically conjugate with the first multi-lens array 74a (first lens 74am). A light emission region of the excitation light source section 103 is arranged at a position optically conjugate with the second multi-lens array 74b.

The polarization separation element 75 is arranged at the intersection of the optical axis ax1 and the illumination optical axis AX3, which are orthogonal to each other. The polarization separation element 75 has a polarization separation function of separating light that has passed through the first phase difference plate 73 into an S-polarized component and a P-polarized component with respect to the polarization separation element 75. Specifically, the polarization separation element 75 reflects the light ray BLs of the S-polarized component of incident light and transmits the light ray BLp of the P-polarized component of the incident light.

The light ray BLs, which is the S-polarized component, is reflected by the polarization separation element 75 and travels toward the wavelength conversion element 70. The light ray BLp, which is the P-polarized component, is transmitted through the polarization separation element 75 and travels toward the diffusion device 26. That is, the polarization separation element 75 causes the light ray BLs, which is a part of the excitation light BL incident from the excitation light source section 103, to be incident on the wavelength conversion element 70, and causes a light ray BLp, which is another part of the excitation light BL, to be incident on the diffusion member 28 of the diffusion device 26.

The polarization separation element 75 has a color separation function of transmitting fluorescence YL (to be described later), which has a different wavelength band than the excitation light BL from the excitation light source section 103, regardless of its polarization state.

The S-polarized light ray BLs emitted from the polarization separation element 75 is incident on the first condensing optical system 76. The first condensing optical system 76 condenses the light ray BLs toward the wavelength conversion element of the wavelength conversion element 70. The first condensing optical system 76 is composed of, for example, a pickup lens 76a and a pickup lens 76b. The light ray BLs emitted from the first condensing optical system 76 is incident on the wavelength conversion element 70.

The wavelength conversion element 70 converts the incident light ray BLs into fluorescence (converted light) YL in a different wavelength band.

The wavelength conversion element 70 emits the yellow fluorescence YL excited by the light ray BLs incident as the excitation light and including red light and green light from the front surface. As the wavelength conversion element 70, for example, YAG:Ce in which cerium ions (for example, Ce³⁺) are added to a garnet crystal of Y₃Al₅O₁₂ (YAG) is used. The wavelength conversion element 70 may include an appropriate scattering element (not shown).

The fluorescence YL emitted from the wavelength conversion element 70 is collimated by the first condensing optical system 76 and transmitted through the polarization separation element 75.

On the other hand, the P-polarized light ray BLp emitted from the polarization separation element 75 is incident on the second phase difference plate 78. The second phase difference plate 78 is composed of a ¼ wavelength plate (λ/4 plate) arranged in an optical path between the polarization separation element 75 and the diffusion device 26. The light ray BLp is converted into, for example, right-handed circularly polarized blue light BLc1 by being transmitted through the second phase difference plate 78. The blue light BLc1 transmitted through the second phase difference plate 78 is incident on the second condensing optical system 79.

The second condensing optical system 79 condenses the blue light BLc1 toward the diffusion device 26. The second condensing optical system 79 is composed of, for example, a pickup lens 79a and a pickup lens 79b.

The diffusion device 26 diffuses and reflects the blue light BLc1 emitted from the second condensing optical system 79 toward the polarization separation element 75. In the case of the present embodiment, the diffusion device 26 is arranged such that the diffusion member 28 is orthogonal to an incident direction of light.

Hereinafter, the blue light BLc1 diffused and reflected by the diffusion device 26 is referred to as blue light BLc2. According to the present embodiment, the blue light BLc2 with a substantially uniform illuminance distribution is obtained by diffusing and reflecting the blue light BLc1. For example, right-handed circularly polarized blue light BLc1 is reflected as left-handed circularly polarized blue light BLc2.

The blue light BLc2 is converted into parallel light by the second condensing optical system 79, and then is incident on the second phase difference plate 78 again. The left-handed circularly polarized blue light BLc2 is converted into the S-polarized blue light BLs1 by the second phase difference plate 78. The S-polarized blue light BLs1 is reflected toward the superimposition optical system 90 by the polarization separation element 75.

The polarization separation element 75 combines the fluorescence YL, which is the converted light emitted from the wavelength conversion element 70, with the blue light BLs1, which is the diffused light diffused by the diffusion member 28 of the diffusion device 26, to generate white light (combined light) WL1, and emits the white light WL1 toward the superimposition optical system 90.

The superimposition optical system 90 includes an integrator optical system 91, a polarization conversion element 92, and a superimposing lens 93. The superimposition optical system 90 homogenizes the intensity distribution of the white light WL1 in an illuminated region. The white light WL1 emitted from the superimposition optical system 90 is incident on the color separation optical system 3.

Specifically, the integrator optical system 91 is composed of, for example, a lens array 91a and a lens array 91b. The lens arrays 91a and 91b are composed of a plurality of lenses arranged in an array.

The lens array 91b, together with the superimposing lens 93, forms images of each lens of the lens array 91a in the vicinity of image formation regions of the light modulation device 4R, the light modulation device 4G, and the light modulation device 4B.

The white light WL1 that has passed through the integrator optical system 91 is incident on the polarization conversion element 92. The polarization conversion element 92 is composed of, for example, a polarization separation film and a phase difference plate, and converts the white light WL1 into linearly polarized light. The polarization conversion element 92 may be omitted if necessary.

The white light WL1 passing through the polarization conversion element 92 is incident on the superimposing lens 93. The superimposing lens 93 condenses partial beams emitted from the polarization conversion element 92 and superimposes them in the vicinity of an image formation region of the light modulation device 4R, the light modulation device 4G, and the light modulation device 4B. In the present embodiment, the integrator optical system 91 and the superimposing lens 93 homogenize the illuminance distribution in an illuminated region.

The blue light BLs1 included in the white light WL1 is laser light, is incident on the light modulation device 4B as the blue light BL, and generates a blue image of a projection image. For this reason, speckle noise may be generated.

On the other hand, according to the illumination device 102 of the present embodiment, the excitation light BL consisting of a plurality of blue beams in which mutual interference is suppressed by causing the oscillation states of the light emitting elements 60a to 60d of the light source packages 231 to 234 in the excitation light source section 103 to be different from each other is emitted, and the blue light BLs1 is diffused by the diffusion member 28 of the diffusion device 26. By this, since the blue light BLs1 superimposes a plurality of speckle patterns which do not interfere with each other on a screen, it is possible to display a high-quality image in which the speckle noise of the blue light BL is reduced.

The technical scope of the present disclosure is not limited to the above-described embodiment, and various modifications can be made without departing from the spirit of the present disclosure.

In the above-described embodiment, as a configuration in which the oscillation state of each light emitting element is made different from each other, the case where the drive frequencies of the laser light emitting elements are different, the duty ratios of the PWM control of the laser light emitting elements are different, or the aspect ratios of the light emitting surfaces of the laser light emitting elements are different has been exemplified, but the disclosure is not limited thereto.

For example, the red light source section 21 may use packages from different makers for the light source packages 211 to 214. In general, packages manufactured by different makers have different constituent materials or composition ratios of light emitting elements, or even if the constituent materials are the same, the composition ratios are different. Here, the composition ratio means, for example, a difference in the type or ratio of impurities contained in a cladding layer.

In this way, if the light emitting elements have different constituent materials or composition ratios, the light emitting elements have different oscillation states. That is, it is possible to reduce the speckle noise of the red illumination light LR by configuring each light source package 211 to 214 using packages from different makers.

The same applies to the green light source section 22 and the blue light source section 23 as to the red light source section 21. That is, the green light source section 22 can reduce the speckle noise of the green illumination light LG by adopting packages from different makers as the light source packages 221 to 224. The blue light source section 23 can reduce the speckle noise of the blue illumination light LB by adopting packages from different makers as the light source packages 231 to 234.

Although the case where each of the light source sections 21, 22, and 23 of the above-described embodiment includes a plurality of light source packages has been described as an example, each of the light source sections 21, 22, and 23 may have one light source package. For example, when the red light source section 21 is taken as an example, the red light source section 21 is configured of only the first red light source package 211, and the oscillation states of a plurality of the first red laser light emitting elements 40a of the first red light source package 211 are different from each other. In this configuration, one of the plurality of the first red laser light emitting elements 40a corresponds to the “first laser light emitting element” in the claims, and another one of the plurality of the first red laser light emitting elements 40a corresponds to the “second laser light emitting element” in the claims.

Similarly, the green light source section 22 may be configured of only the first green light source package 221, and the oscillation states of a plurality of the first green laser light emitting elements 50a of the first green light source package 221 may be different from each other. The blue light source section 23 may be configured of only the first blue light source package 231, and the oscillation states of a plurality of the first blue laser light emitting elements 60a of the first blue light source package 231 may be different from each other.

In the above-described embodiment, while an example where the oscillation states of the light emitting elements are different in each of the light source sections 21, 22, and 23 has been presented, speckle noise may be reduced by making the oscillation state of at least one light emitting element in each of the light source sections 21, 22, and 23 different from the others. When the disclosure is applied to only one of the light source sections 21, 22, and 23, it is desirable to apply the disclosure to the red light source section 21, which emits the red illumination light LR, in which speckle noise is likely to be conspicuous.

Although the illumination device of the above-described embodiment includes a rotary diffusion device, the diffusion device may not necessarily be rotatable and may be a fixed type.

Furthermore, the specific description of the shape, number, arrangement, material, and the like of each component of the illumination device and the projector is not limited to the above-described embodiment and can be appropriately modified. In the above-described embodiment, an example in which the illumination device according to the present disclosure is mounted on the projector using a liquid crystal panel has been described, but the disclosure is not limited to this. The illumination device according to the present disclosure may be applied to a projector using a digital micromirror device as a light modulation device. The projector may not include a plurality of light modulation devices, and may be a single-plate projector including only one light modulation device.

In the above-described embodiment, the example in which the illumination device according to the disclosure is applied to the projector is described, but the disclosure is not limited to this. The illumination device of the present disclosure can also be applied to a lighting fixture, a headlight of an automobile, or the like.

### OUTLINE OF PRESENT DISCLOSURE

Hereinafter, an outline of the present disclosure is appended.

### First Note

A projector includes a first laser light emitting element that emits first light; a second laser light emitting element that emits second light having a same peak wavelength as the first light; a diffusion member on which the first light and the second light are incident; a superimposition optical system on which light emitted from the diffusion member is incident; a light modulation device that modulates light incident from the superimposition optical system a in accordance with image information; and projection optical device that projects light modulated by the light modulation device, wherein the first laser light emitting element and the second laser light emitting element have oscillation states different from each other.

According to the projector including this configuration, by making the oscillation states of the light emitting elements different from each other, it is possible to suppress mutual interference between the first light and the second light emitted from the light emitting elements. Therefore, the first light and the second light can superimpose speckle patterns on a projected surface that do not interfere with each other.

Therefore, according to the projector including this configuration, it is possible to display a high-quality image with reduced speckle noise.

### Second Note

The projector according to the first note further includes a first light source package having a package structure in which a plurality of first laser light emitting elements are mounted and a second light source package having a package structure in which a plurality of second laser light emitting elements are mounted.

According to this configuration, since the projector includes the first light source package and the second light source package made of a so-called multi-emitter package structure, it is possible to miniaturize the device configuration while generating high luminance light with reduced speckle noise.

### Third Note

The projector according to the second note, wherein a first drive frequency in the first laser light emitting element of the first light source package and a second drive frequency in the second laser light emitting element of the second light source package are different from each other.

According to this configuration, by making the duty ratios by the pulse width modulation control different from each other, it is possible to easily realize a configuration in which the oscillation states of the first laser light emitting element and the second laser light emitting element are made different from each other.

### Fourth Note

The projector according to the third note, wherein the first drive frequency and the second drive frequency do not have an integer multiple relationship with each other.

According to this configuration, one of the drive frequencies of the first light source package and the second light source package is not included in the other. Therefore, the mutual interference between the first light and the second light can be more desirably suppressed.

### Fifth Note

The projector according to the second note, wherein when driving of the first laser light emitting element of the first light source package and the second laser light emitting element of the second light source package is controlled by pulse width modulation, a first duty ratio for controlling the first laser light emitting element and a second duty ratio for controlling the second laser light emitting element are different from each other.

According to this configuration, by making the duty ratios by the pulse width modulation control different from each other, it is possible to easily realize a configuration in which the oscillation states of the first laser light emitting element and the second laser light emitting element are made different from each other.

### Sixth Note

The projector according to the first note or the second note, wherein a first aspect ratio of a first light emitting surface of the first laser light emitting element and a second aspect ratio of a second light emitting surface of the second laser light emitting element are different from each other.

According to this configuration, since the aspect ratios of the light emitting surfaces are different from each other, it is possible to easily realize a configuration in which the oscillation states of the first laser light emitting element and the second laser light emitting element are different from each other. Seventh note

The projector according to the first note or the second note, wherein constituent materials or composition ratios of the first laser light emitting element and the second laser light emitting element are different from each other.

According to this configuration, by making the constituent materials or the composition ratios of the light emitting elements different, it is possible to easily realize a configuration in which the oscillation states of the first laser light emitting element and the second laser light emitting element are made different from each other.

### Eighth Note

The projector according to any one of the first note to the seventh note further includes a wavelength conversion element that converts incident light into converted light of a different wavelength band and a light separating and combining element to which the first light and the second light are incident, that causes a part of the first light and the second light to be incident on the wavelength conversion element, and that causes an other part of the first light and the second light to be incident on the diffusion member, wherein the light separating and combining element emits illumination light obtained by combining the converted light emitted from the wavelength conversion element and diffused light diffused by the diffusion member toward the superimposition optical system.

According configuration, it is possible to suppress the speckle noise due to diffused light when generating light obtained by combining converted light, whose wavelength has been converted by the wavelength conversion element, with the diffused light by the diffusion member.

### Ninth Note

The projector according to any one of the first note to the eighth note, wherein the first light and the second light are red light.

According to this configuration, it is possible to reduce the speckle noise of red light, which is highly visible to humans. Therefore, the effect of reducing speckle noise can be efficiently obtained.

### Tenth Note

The projector according to the ninth note further includes a third laser light emitting element that emits third light having a wavelength band different from that of the first light; a fourth laser light emitting element that emits fourth light having a same peak wavelength as the third light; a fifth laser light emitting element that emits fifth light having a wavelength band different from that of the first light and the third light; a sixth laser light emitting element that emits sixth light having a same peak wavelength as the fifth light; and a light combining section that combines the first light, the second light, the third light, the fourth light, the fifth light, and the sixth light, and that emits combined light, wherein the third light and the fourth light are blue light, and the fifth light and the sixth light are green light, the third laser light emitting element and the fourth laser light emitting element have different oscillation states from each other, the fifth laser light emitting element and the sixth laser light emitting element have different oscillation states from each other, and the combined light emitted from the light combining section is incident on the diffusion member.

According to this configuration, it is possible to reduce the speckle noise of white light composed of laser light including red light, green light, and blue light. Therefore, it is possible to provide a projector that projects a full-color image with reduced the speckle noise.

What is claimed is:

1. A projector comprising:
a first laser light emitting element that emits first light;
a second laser light emitting element that emits second light having a same peak wavelength as the first light;
a diffusion member on which the first light and the second light are incident;
a superimposition optical system on which light emitted from the diffusion member is incident;
a light modulation device that modulates light incident from the superimposition optical system in accordance with image information; and
a projection optical device that projects light modulated by the light modulation device, wherein
the first laser light emitting element and the second laser light emitting element have oscillation states different from each other.

2. The projector according to claim 1, further comprising:
a first light source package having a package structure in which a plurality of first laser light emitting elements are mounted and
a second light source package having a package structure in which a plurality of second laser light emitting elements are mounted.

3. The projector according to claim 2, wherein
a first drive frequency in the first laser light emitting element of the first light source package and a second drive frequency in the second laser light emitting element of the second light source package are different from each other.

4. The projector according to claim 3, wherein
the first drive frequency and the second drive frequency do not have an integer multiple relationship with each other.

5. The projector according to claim 2, wherein
when driving of the first laser light emitting element of the first light source package and the second laser light emitting element of the second light source package is controlled by pulse width modulation, a first duty ratio for controlling the first laser light emitting element and a second duty ratio for controlling the second laser light emitting element are different from each other.

6. The projector according to claim 1, wherein
a first aspect ratio of a first light emitting surface of the first laser light emitting element and a second aspect ratio of a second light emitting surface of the second laser light emitting element are different from each other.

7. The projector according to claim 1, wherein
constituent materials or composition ratios of the first laser light emitting element and the second laser light emitting element are different from each other.

8. The projector according to claim 1, further comprising:
a wavelength conversion element that converts incident light into converted light of a different wavelength band and
a light separating and combining element to which the first light and the second light are incident, that causes a part of the first light and the second light to be incident on the wavelength conversion element, and that causes an other part of the first light and the second light to be incident on the diffusion member, wherein
the light separating and combining element emits illumination light obtained by combining the converted light emitted from the wavelength conversion element and diffused light diffused by the diffusion member toward the superimposition optical system.

9. The projector according to claim 1, wherein
the first light and the second light are red light.

10. The projector according to claim 9, further comprising:
a third laser light emitting element that emits third light having a wavelength band different from that of the first light;
a fourth laser light emitting element that emits fourth light having a same peak wavelength as the third light;
a fifth laser light emitting element that emits fifth light having a wavelength band different from that of the first light and the third light;
a sixth laser light emitting element that emits sixth light having a same peak wavelength as the fifth light; and
a light combining section that combines the first light, the second light, the third light, the fourth light, the fifth light, and the sixth light, and that emits combined light, wherein
the third light and the fourth light are blue light, and the fifth light and the sixth light are green light,
the third laser light emitting element and the fourth laser light emitting element have different oscillation states from each other,
the fifth laser light emitting element and the sixth laser light emitting element have different oscillation states from each other, and
the combined light emitted from the light combining section is incident on the diffusion member.
